(19) United States
(12) Patent Application Publication
(10) Pub. No.: US 2002/0071976 A1
(43) Pub. Date: Jun. 13, 2002

(54) Sulfur-absorbent bed and fuel processing assembly incorporating the same

(76) Inventor: David J. Edlund, Bend, OR (US)

Correspondence Address: Kolisch, Hartwell, Dickinson,, McCormack & Heuser, Suite 200, 520 S.W. Yamhill Street, Portland, OR, 97204, US

(21) Appl. No.: 10/015,845

(22) Filed: Nov. 1, 2001

Related U.S. Application Data
(60) Provisional application No. 60/246,005, filed on Nov. 3, 2000.

(51) Int. Cl. H01M 8/06; B01J 8/02

(52) U.S. Cl. 429/19; 422/211

(57) ABSTRACT

A fuel processing system that includes an improved sulfur-removal assembly. The fuel processing system includes at least one fuel processor adapted to produce hydrogen gas from water and a carbon-containing feedstock, such as at least one hydrocarbon or alcohol. The sulfur-removal assembly includes a sulfur-absorbent bed that contains a sulfur-absorbent material, such as a low-temperature shift (LTS) catalyst, that is adapted to remove, or reduce the concentration of, sulfur-compounds from the carbon-containing feedstock.

### RELATED APPLICATION

The present application claims priority to co-pending U.S. patent application Ser. No. 60/246,005, which was filed on Nov. 3, 2000, is entitled “Sulfur-Absorbent Bed and Fuel Processing Assembly Incorporating the Same,” and the complete disclosure of which is hereby incorporated by reference for all purposes.

### FIELD OF THE INVENTION

The present invention relates generally to fuel processing systems, and more particularly to fuel processing systems that utilize a reforming catalyst to produce hydrogen gas from a reforming feedstock.

### BACKGROUND OF THE INVENTION

Purified hydrogen is used in the manufacture of many products including metals, edible fats and oils, and semiconductors and microelectronics. Purified hydrogen is also an important fuel source for many energy conversion devices. For example, fuel cells use purified hydrogen and an oxidant to produce an electrical potential. A process known as steam reforming produces by chemical reaction hydrogen and certain byproducts or impurities. A subsequent purification process may be employed to remove undesirable impurities to provide hydrogen sufficiently purified for application to a fuel cell.

In a steam reforming process, one reacts steam and a carboncontaining feedstock in the presence of a reforming catalyst. Steam reforming requires an elevated operating temperature, e.g., between 250 degrees centigrade and 900 degrees centigrade, and produces primarily hydrogen and carbon dioxide, with lesser quantities of carbon monoxide also being formed. Trace quantities of unreacted reactants and trace quantities of byproducts also can result from steam reforming. Examples of suitable carbon-containing feedstocks include, but are not limited to, alcohols (such as methanol or ethanol) and hydrocarbon fuels (such as methane, propane, gasoline, diesel or kerosene).

Nearly all hydrocarbon fuels contain organic sulfur compounds in varying concentrations, typically in the range of approximately 3 ppm to approximately 300 ppm. These sulfur compounds will poison conventional steam reforming (and autothermal reforming) catalysts and, therefore, must be removed from the hydrocarbon fuel prior to delivery to the reforming catalyst.

Typically, the concentration of sulfur compounds is reduced by passing the hydrocarbon feedstock through a bed that contains an absorbent material adapted to reduce the concentration of these sulfur compounds from the feedstock. Some known absorbent materials are based on zinc oxide. These materials are not completely effective in removing organic sulfur compounds due to the poor reactivity of some organic sulfur compounds, such as thiophene and organic sulfides. Although zinc oxide is generally effective at removing hydrogen sulfide from the hydrocarbon feedstock, it is not as effective in removing other sulfur-containing compounds. Other absorbent materials are based on nickel oxide. Nickel forms compounds with most sulfur compounds, although it typically requires a higher operating temperature. However, hydrocarbon feedstocks tend to form coke on nickel, which reduces the reactivity of the nickel because the reaction sites are blocked by the coke.

### SUMMARY OF THE INVENTION

The present invention is directed to a fuel processing system that includes an improved sulfur-removal assembly. The fuel processing system includes at least one fuel processor adapted to produce hydrogen gas from water and a carbon-containing feedstock, such as at least one hydrocarbon or alcohol. The sulfur-removal assembly includes a sulfur-absorbent bed that contains a sulfur-absorbent material, such as a low-temperature shift (LTS) catalyst, that is adapted to remove, or reduce the concentration of, sulfur-compounds from the carbon-containing feedstock.

Many features of the present invention will become manifest to those versed in the art upon making reference to the detailed description which follows and the accompanying sheets of drawings in which preferred embodiments incorporating the principles of this invention are disclosed as illustrative examples only.

### BRIEF DESCRIPTION OF THE DRAWINGS

FIG. 1 is a schematic diagram of a fuel processing system according to the present invention.

FIG. 2 is a schematic diagram of another embodiment of the fuel processing system of FIG. 1.

FIG. 3 is a schematic diagram of another embodiment of the fuel processing system of FIG. 1.

FIG. 4 is a schematic diagram of a sulfur-removal assembly according to the present invention.

FIG. 5 is a schematic diagram of the assembly of FIG. 4 including a heating assembly.

FIG. 6 is a schematic diagram of the assembly of FIG. 4 including a heating assembly.

FIG. 7 is a schematic diagram of the assembly of FIG. 4 including a heating assembly.

FIG. 8 is a schematic diagram of the assembly of FIG. 4 including a heating assembly.

FIG. 9 is a schematic diagram of the fuel processing system of FIG. 1 including a controller adapted to monitor the status of the sulfur-removal assembly.

FIG. 10 is a schematic diagram of the fuel processing system of FIG. 9 having a plurality of sulfur-absorbent beds.

FIG. 11 is a schematic diagram of a steam reformer that may be used with the sulfur-removal device of the present invention.

FIG. 12 is a schematic diagram of another embodiment of the steam reformer of FIG. 11.

FIG. 13 is a schematic diagram of an illustrative fuel cell stack.

FIG. 14 is a schematic diagram of a sulfur-removal assembly according to the present invention.

FIG. 15 is a schematic diagram of a sulfur-removal assembly according to the present invention.

FIG. 16 is a schematic diagram of a sulfur-removal assembly according to the present invention.

FIG. 17 is a schematic diagram of a sulfur-removal assembly according to the present invention.

FIG. 18 is a schematic diagram of a sulfur-removal assembly according to the present invention.

### DETAILED DESCRIPTION AND BEST MODE OF THE INVENTION

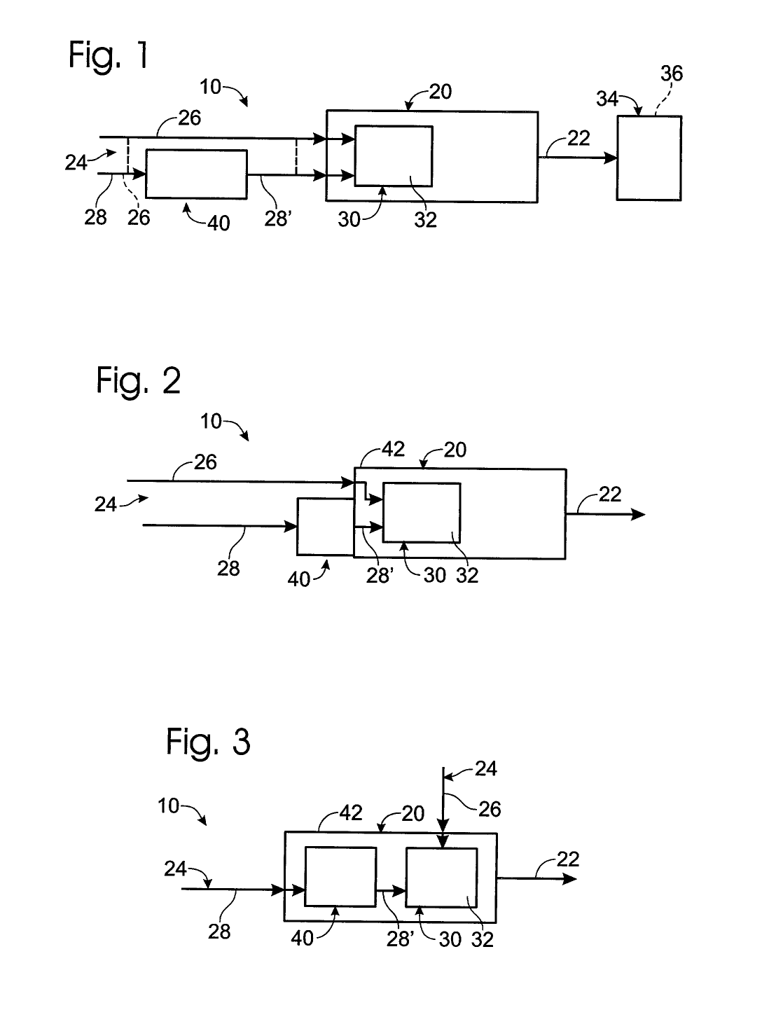

A fuel processing system according to the present invention is shown in FIG. 1 and generally indicated at 10. System 10 includes at least one fuel processor 20 adapted to produce a product hydrogen stream 22 from a feed stream 24. Feed stream 24 includes a carbon-containing feedstock 28, such as at least one hydrocarbon or alcohol. Examples of suitable hydrocarbons include methane, propane, natural gas, diesel, kerosene, gasoline and the like. Examples of suitable alcohols include methanol, ethanol, and polyols such as ethylene glycol and propylene glycol.

In some embodiments, feed stream 24 further includes water 26, which may be delivered to the fuel processor independent of the carbon-containing feedstock or in the same fluid stream as the carbon-containing feedstock. In FIG. 1, feed stream 24 is shown including separate water and carbon-containing feedstock streams. This configuration is typically used when the carbon-containing feedstock is a hydrocarbon, although it can be used with alcohol or other water-miscible feedstocks 28. To graphically illustrate that the water and carbon-containing feedstock may be mixed prior to delivery to fuel processor 20, dashed lines are used in FIG. 1 to indicate that feed stream 24 may include a single stream containing water 26 and carbon-containing feedstock 28, and to indicate separate water and carbon-containing feedstock streams that are mixed prior to delivery to the fuel processor.

Fuel processor 20 includes a hydrogen-producing region 30 in which product hydrogen stream 22 is produced from feed stream 24. Fuel processor 20 may produce hydrogen gas from water 26 and carbon-containing feedstock 28 through any suitable mechanism. Examples of suitable mechanisms include steam reforming and autothermal reforming, in which reforming catalysts are used to produce hydrogen gas from carbon-containing feedstock 28 and water 26. Another suitable mechanism for producing hydrogen gas is catalytic partial oxidation of an alcohol or hydrocarbon. Typically, the hydrogen-producing region will include at least one catalyst bed 32, such as a reforming catalyst bed or partial oxidation catalyst bed. In the context of a steam reformer, hydrogen-producing region 30 may be referred to as a reforming region 30 and catalyst bed 32 may be referred to as a reforming catalyst bed or a steam reforming catalyst bed. Similarly, in the context of an autothermal reformer, hydrogen-producing region 30 may be referred to as an autothermal reforming region 30 and catalyst bed 32 may be referred to as an autothermal reforming catalyst bed.

System 10 may, but does not necessarily, include at least one fuel cell stack 34. Each fuel cell stack 34 includes at least one, and typically includes multiple, fuel cells 36 adapted to produce an electric current from hydrogen gas, such as stream 22 from fuel processor 20. Examples of suitable fuel cells include proton exchange membrane (PEM) fuel cells and alkaline fuel cells. Some or all of stream 22 may additionally, or alternatively, be delivered, via a suitable conduit, for use in another hydrogen-consuming process, burned for fuel/heat, or stored for later use. Examples of suitable storage mechanisms include pressurized tanks and hydride beds.

An illustrative example of a fuel cell stack is shown in FIG. 13. Stack 34 (and the individual fuel cells 36 contained therein) includes an anode region 130 and a cathode region 132, which are separated by an electrolytic membrane or barrier 134 through which hydrogen ions may pass. The anode and cathode regions respectively include anode and cathode electrodes 136 and 138. Anode region 130 of the fuel cell stack receives hydrogen stream 22. Cathode region 132 receives an air stream 140, and releases a cathode air exhaust stream 142 that is partially or substantially depleted in oxygen. Electrons liberated from the hydrogen gas cannot pass through barrier 134, and instead must pass through an external circuit 144, thereby producing an electric current that may be used to meet the electrical load applied by the one or more devices 146, as well as to power the operation of the fuel processing system.

Anode region 130 is periodically purged, and releases a purge stream 147, which may contain hydrogen gas. Alternatively, hydrogen gas may be continuously vented from the anode region of the fuel cell stack and re-circulated. An electric current is produced by fuel cell stack 34 to satisfy an applied load, such as from device 146. Also shown in FIG. 2 is an air delivery assembly 148, which is adapted to deliver an air stream 152 to fuel cell stack 34, such as to cathode region 132. Air delivery assembly 148 is schematically illustrated in FIG. 13 and may take any suitable form. It is within the scope of the present invention that air delivery assembly 148 may be a single device, or separate devices. Similarly, air delivery assembly 148 may also provide an air stream to is fuel processor 20, or fuel processor 20 may include its own air delivery system.

System 10 further includes a sulfur-removal assembly 40 that is adapted to remove sulfur compounds from carbon-containing feedstock 28 to produce a feedstock 28′ that has a reduced concentration of sulfur compounds. In embodiments in which the feed stream includes water and carbon-containing feedstock, it should be understood that assembly 40 may be used to remove these compounds from the stream containing carbon-containing feedstock before or after mixing with water 26. For example, dashed lines are used in FIG. 1 to indicate graphically a single stream that contains carbon-containing feedstock 28 and water 26, and illustrative mixing points for separate streams containing water 26 and carbon-containing feedstock 28. It is also within the scope of the invention that the carbon-containing feedstock and water will not be mixed until after they are vaporized.

In FIG. 1, sulfur-removal assembly 40 is shown separate from fuel processor 20. By “separate” it is meant that the sulfur-removal system is in fluid communication with the fuel processor, but physically spaced-apart from the fuel processor. It is within the scope of the present invention, however, that assembly 40 may be directly coupled to the fuel processor or contained within the shell 42 of the fuel processor, such as shown in FIGS. 2 and 3.

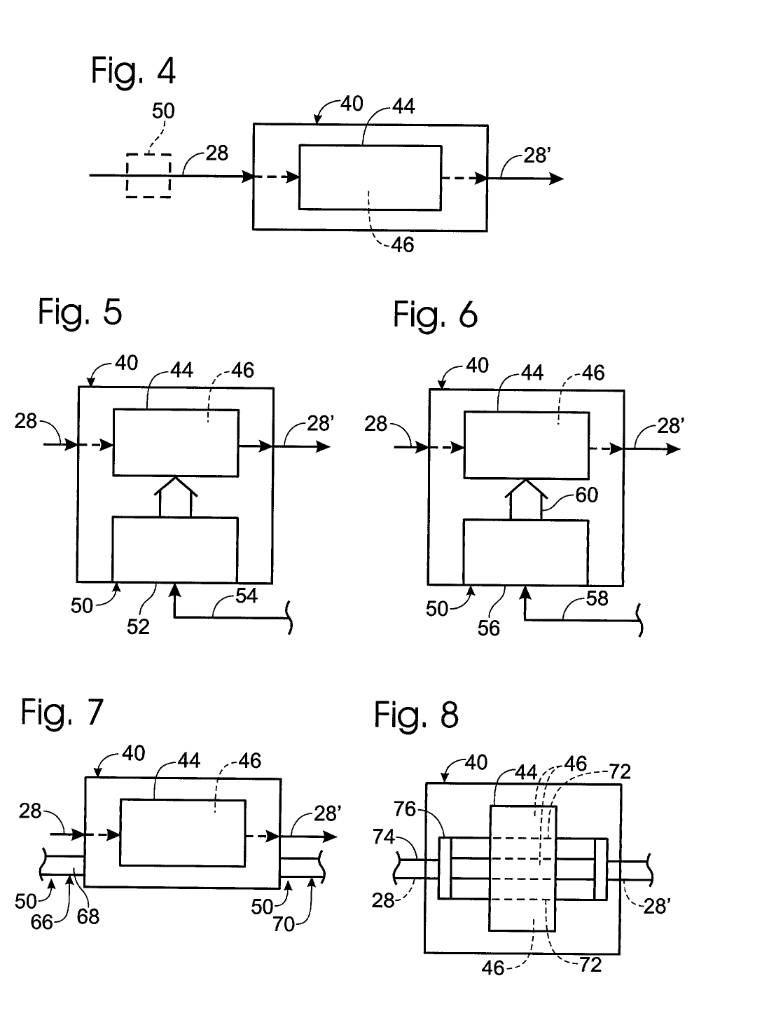

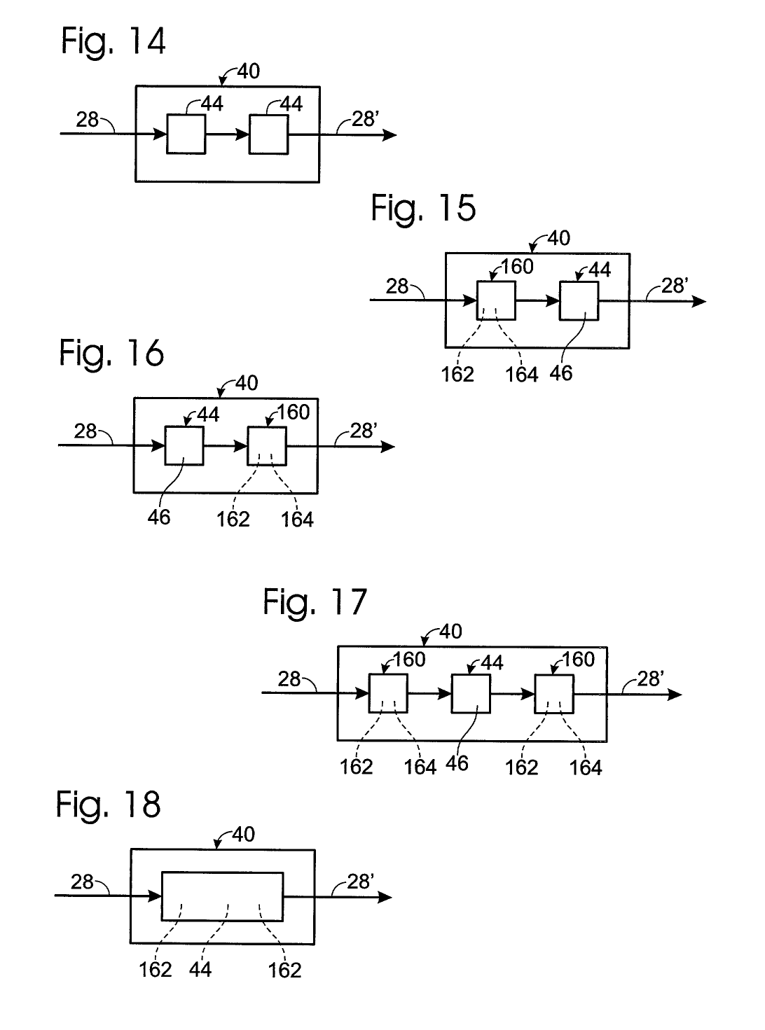

As shown in FIG. 4, assembly 40 includes at least one sulfur-absorbent bed 44 through which the carbon-containing feedstock is passed prior to delivery to the reforming region of the fuel processor. Although a single sulfur-absorbent bed 44 is shown in FIG. 4, it should be understood that the number and sizes of beds 44 may vary, and therefore assembly 40 may include two or more beds, including two or more beds in parallel (as shown in FIG. 10) and/or in series (as shown in FIG. 14). Each bed 44 contains a sulfur-absorbent material 46 that is adapted to remove sulfur compounds from the carbon-containing feedstock to produce feedstock 28′ that has a reduced concentration of sulfur compounds. Preferably, material 46 does not catalyze methane or coke formation at the operating conditions in assembly 40.

As used herein, the term “bed” is meant to broadly include not only packed columns or tubes through which the carbon-containing feedstock is passed, but also other relatively high surface area, relatively low pressure drop structures or regions of other structures in which sulfur-absorbent material 46 is positioned or otherwise supported for contact with the carbon-containing feedstock 28. Examples of other beds within the scope of the invention include filters impregnated with or otherwise containing material 46, and porous supports upon which material 46 is supported. Examples of these supports include porous materials such as ceramic materials, mesh or other woven fabrics or screens, and corrugated materials.

Similarly, while assembly 40 is schematically illustrated with at least one bed 44 contained therewithin, this schematic representation should not be construed as requiring or excluding a housing external the bed(s). Therefore, it is within the scope of the invention that the bed may include a jacket or shell that surrounds and is spaced-apart from the housing of the bed, and that the bed may be formed without such a jacket.

An example of a suitable sulfur-absorbent material 46 is a low temperature shift (LTS) catalyst. LTS catalysts are readily poisoned by sulfur compounds, and therefore are effective at removing these compounds from carbon-containing feedstocks. LTS catalysts are also more reactive than zinc oxide, and therefore are more effective than zinc oxide at removing sulfur compounds from carbon-containing feedstocks. Furthermore, LTS catalysts do not catalyze coke formation at the operating conditions in assembly 40.

LTS catalysts are typically compositions of copper and zinc, and are available in various forms and shapes. A suitable shape for use in an absorbent bed is pellets. LTS catalyst that is extruded into a desired shape is another example, as is LTC catalyst in granular, or powder, form. Typically, LTS catalysts containing copper and zinc will include approximately 10-90% copper (I) and/or copper (II) oxide and approximately 10-90% zinc oxide. As used herein, “copper oxide” shall mean copper (I) and/or copper (II) oxide. The LTS catalysts may further include other materials, such as 0-50% alumina. Other examples of LTS catalysts may be described as containing 20-60% copper oxide, 20-50% copper oxide, or 20-40% copper oxide. Still others include these illustrative ranges of copper oxide and 20-60% zinc oxide, 20-50% zinc oxide or 30-60% zinc oxide. Other LTS catalysts contain chromium. The LTS catalysts may also include other sulfur-absorbing materials, inerts and/or support materials. An example of a suitable LTS catalyst is made by ICI Chemicals & Polymers, Ltd. of Billingham, England and sold under the trade name 52-1. This LTS catalyst contains approximately 30% copper (II) oxide, approximately 45% zinc oxide and approximately 13% alumina. Another example of a suitable LTS catalyst is G66B made and sold by Süd-Chemie, Inc., Louisville, Ky. Other suitable LTS catalysts include K3-100, which is made and sold by BASF Corporation.

It should be understood that other LTS catalysts may be used, so long as they meet the criteria set forth below. A suitable LTS catalyst should be effective at removing sulfur compounds from carbon-containing feedstock 28 at operating temperatures less than approximately 350° C., capable of catalyzing the conversion of carbon monoxide and water to yield hydrogen and carbon dioxide at temperatures less than approximately 350° C. and should be generally poisoned by sulfur concentrations of approximately 1-10 ppm at temperatures less than approximately 350° C.

In practice, the carbon-containing feedstock is passed through sulfur-absorbent bed 44 containing LTS catalyst pellets. The bed is operated at a temperature ranging from approximately 20° C. to approximately 400° C., and preferably operated at a temperature ranging from approximately 100° C. to approximately 400° C. Organic sulfur compounds (and hydrogen sulfide if it is present) react with the LTS catalyst pellets under these conditions to form stable sulfides of copper and zinc, thereby retaining the sulfur and producing a stream that has been reduced in sulfur concentration. An advantage of using LTS catalyst is that neither copper nor zinc are especially active for the formation of carbon (coke) from hydrocarbons.

Preferably, assembly 40 includes, or is in thermal communication with, a heating assembly 50. By “thermal communication,” it is meant that a heating assembly delivers heat to the sulfur-removal assembly, regardless of whether the heating assembly is integrated into the sulfur-removal assembly or spaced away from the sulfur-removal assembly and adapted to deliver a heated fluid stream thereto. For example, a furnace or combustion region separate from the sulfur-removal assembly may be used to heat the sulfur-removal assembly (or at least the bed or beds therein). Alternatively, or additionally, the bed may be heated by delivering a hot exhaust stream to the sulfur-removal assembly.

In FIG. 5, an example of a suitable heating assembly 50 is shown in the form of an electric heater 52 that heats beds 44. Heater 52 may take any suitable configuration and is powered by electric current 54, such as from an external source or from fuel cell stack 34. Another illustrative example of a suitable heating assembly 50 is shown in FIG. 6 in the form of a combustion chamber 56 that combusts a fuel stream 58 to produce a heated combustion gas stream 60 that may be used to heat the bed or beds within sulfur-removal assembly 40. Combustion chamber 56 may include a burner, combustion catalyst, spark or glow plug, or other suitable ignition source. Fuel stream 58 may be any suitable combustible stream, such as a fuel stream from an external source, a portion of hydrogen gas stream 22, a combustible byproduct stream from fuel processor 20, or combinations thereof.

Heating assembly 50 may also take the form of one or more heated streams that heat the sulfur-removal assembly, or its bed(s), via heat exchange. Illustrative examples of heater assemblies that include heat exchange streams are shown in FIGS. 7 and 8. In FIG. 7, heat exchange stream 66 delivers a heated fluid 68 to sulfur-removal assembly 40 and stream 70 removes the fluid from assembly 40. Streams 66 and 70 may form a continuous fluid loop, or alternatively, stream 70 may deliver the fluid contained therein to a downstream destination for use, storage or disposal. In FIG. 8, sulfur-absorbent bed 44 includes one or more passages 72 through which a heated fluid stream may pass to heat the bed. As shown, bed 44 includes plural passages 72 through which a heated fluid stream 74 flows. Also shown in FIG. 8 is an optional distribution manifold 76 that distributes the fluid in stream 74 between the passages. Examples of suitable heat exchange fluids include, but are not limited to, air, water, oil, ethylene glycol, propylene glycol and silicone fluids.

Heating assembly 50 may additionally, or alternatively, heat beds 44 indirectly by heating the carbon-containing feedstock 28 delivered thereto. Any of the previously described and illustrated heating assemblies may be used to heat the feedstock 28. This has been graphically illustrated in FIG. 4, in which a heating assembly 50 is schematically illustrated heating feedstock 28.

Beds 44 have to be periodically replaced or recharged to retain the sulfur-absorbing properties of the sulfur-absorbent materials 46 contained therein. Typically, a bed will be used to purify hydrocarbon fuels until the bed is at least 80% and less than approximately 98% of its capacity of absorbed sulfur. It should be understood that the bed may be replaced or recharged when at a different percent of its capacity. When the bed reaches a determined capacity, or capacity range, the bed is taken off-line for replacement or recharging.

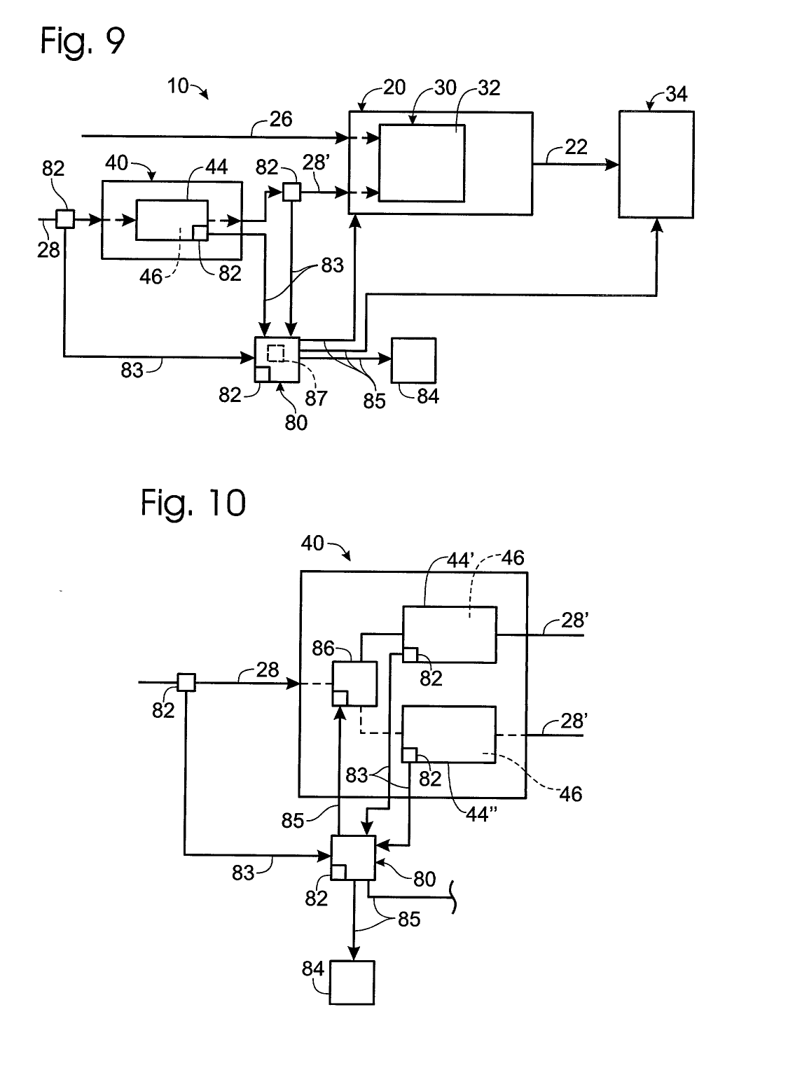

When a single bed 44 is used, it is preferable (but not required) that fuel processing system 10 includes a suitable controller 80 for determining when the desired percentage of capacity has been reached and triggering a user-notifying event in response thereto. An illustrative example of a suitable controller 80 is shown in FIG. 9 and includes a sensor 82 adapted to measure the percentage of the bed's capacity of absorbed sulfur at which the bed is operating. This measurement may be made directly or indirectly with any suitable sensing device. For example, the sensor may be adapted to measure the sulfur content in the beds directly. When the sulfur content of feedstock 28 is known, sensor 82 may take the form of a timer or flowmeter adapted to measure the sulfur content indirectly by respectively measuring the operating time during which the bed has been used or the volume of feedstock that has been passed through the bed. For purposes of illustration, numerous suitable sensors and possible sensor positions have been shown in FIGS. 9 and 10. Sensors 82 communicate with controller 80 via communication links 83, which may be any suitable wired or wireless mechanism for enabling one- or two-directional communication.

Responsive to the measured capacity level compared to stored threshold level, the controller may produce a system response, such as a control signal 85, which, similar to links 83, may be any suitable wired or wireless mechanism for enabling one- or two-directional communication. When the measured level is less than the stored threshold level, no response is required because the sulfur absorbent material still has sufficient remaining sulfur-absorbing capacity. When the measured level reaches or exceeds the threshold level, the controller actuates a user-notifing device 84, such as an audio and/or visual device. As indicated above, controller 80 may include a memory portion 87, or at least one memory device, that is adapted to store at least one threshold value for the at least one sulfur-absorbent bed.

Preferably, the threshold level is selected such that an immediate response is not required by the user before the sulfur-absorbent material has too little remaining capacity to effectively remove sulfur compounds from feedstock 28. More specifically, it is preferable that the controller actuates the user-notifying device prior to the sulfur-absorbent material reaching its capacity for effective removal of sulfur compounds from feedstock 28. For example, the controller may actuate user-notifying device 84 when the measured level is 80%, 85% or 90% of the capacity of the sulfur-absorbent material. It should be understood that any desired threshold level may be used, and that the above levels are merely illustrative examples of suitable levels.

Controller 80 may include more than one threshold level to which the measured capacity level is compared. For example, when the measured capacity level of material 46 exceeds a lower threshold, user-notifying device 84 may be actuated to notify users that the material is nearing its capacity for absorbed sulfur compounds and therefore needs to be replaced or recharged. However, should the measured capacity level reach a higher threshold, which is selected to be at or near the capacity level at which the material can no longer effectively remove sulfur compounds from feedstock 28, then the controller may actuate a system-controlling response, such as shutting down part or all of the fuel processing system or otherwise preventing the feedstock from being delivered to the fuel processor, thereby preventing the reforming catalyst from being poisoned by feedstock that contains sulfur compounds.

As discussed, sulfur-removal assembly 40 may include more than one sulfur-absorbent bed 44. An illustrative embodiment of such an assembly is shown in FIG. 10. As shown, sulfur-removal assembly 40 includes a pair of sulfur-absorbent beds 44, namely beds 44′ and 44″. It should be understood that any number of beds may be used, including more than two beds. Furthermore, the beds may be connected in series and/or parallel. As shown, controller 80 includes a sensor 82 adapted to measure the operating capacity of each bed 44 to determine if the capacity of the beds exceeds one or more stored threshold levels, or values.

In some applications, it may be desirable for assembly 40 to include at least one “spare” bed that is not in operation at any particular time. However, when a particular bed needs to be recharged or replaced, the spare bed may be brought online and the used bed may be brought offline. Once offline, the used bed may be replaced and/or recharged, yet the fuel processing system does not need to be shut down or brought offline. In FIG. 10, controller 80 communicates with a valve assembly 86 that selectively delivers the feedstock to one or more of the beds 44. As shown, valve assembly 86 is adapted to deliver the feedstock to bed 44′. However, responsive to control signals from controller 80, such as when the operating capacity of bed 44′ reaches a threshold level, valve assembly 86 instead delivers the feedstock to bed 44″. Valve assembly 86 may additionally or alternatively be manually controlled, and it may be located internal or external assembly 40. After isolation from the flow of carbon-containing feedstock 28, bed 44′ may be replaced or recharged. One suitable mechanism for recharging the beds, or more particularly the sulfur-absorbent material 46 within the beds, is to roast the material in the presence of oxygen or air to convert the sulfides therein to oxides, and then reduce the oxides to reclaim the base metals.

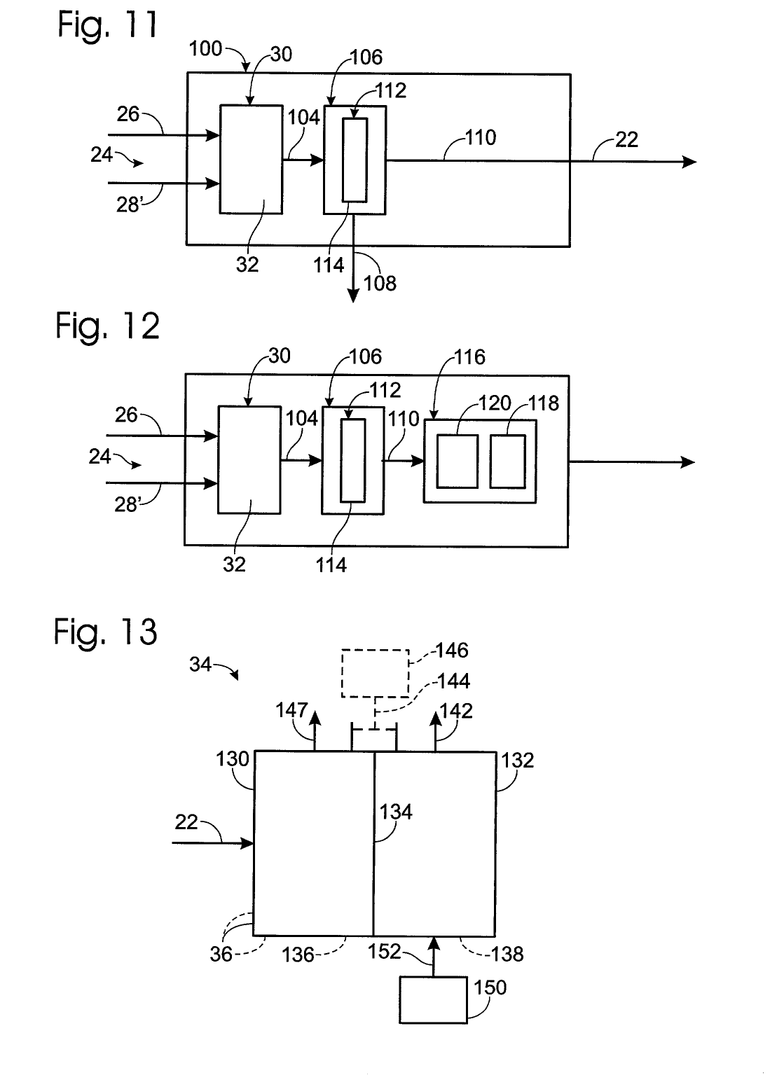

As discussed, any suitable fuel processor 20 that utilizes a reforming catalyst 32 may be used, such as steam reformers and autothermal reformers. Examples of suitable steam reformers are disclosed in U.S. Pat. Nos. 5,861,137 and 5,997,594, and U.S. patent application Ser. Nos. 09/190,917 and 09/802,361, the disclosures of which are hereby incorporated by reference. An example of a suitable fuel processor 20 in the form of a steam reformer 100 is shown in FIG. 11. Reformer 100 includes reforming, or hydrogen-producing, region 30, in which a hydrogen-containing stream, or mixed gas stream, 104 is produced from feed stream 24, which is illustrated in FIG. 11 as separate streams containing water 26 and carbon-containing feedstock 28′. The hydrogen-containing stream typically contains impurities, and therefore is delivered to a separation region, or purification region, 106, where the stream is purified. In separation region 106, the hydrogen-containing stream is separated into one or more byproduct streams 108 and a purified hydrogen stream 110 that forms product hydrogen stream 22 by any suitable pressure-driven separation process. As discussed, product hydrogen stream 22 may be delivered to fuel cell stack 34. Alternatively, or additionally, some or all of stream 22 may be delivered to a suitable storage device, such as a hydride bed or storage tank, or delivered for use in processes requiring purified hydrogen gas.

An example of a suitable structure for use in separation region 106 is a membrane module 112, which contains one or more hydrogen permeable metal membranes 114. An example of a suitable membrane module formed from a plurality of hydrogen-selective metal membranes is disclosed in U.S. Pat. No. 6,221,117, the complete disclosure of which is hereby incorporated by reference. In that application, a plurality of generally planar membranes are assembled together into a membrane module having flow channels through which an impure gas stream is delivered to the membranes, a purified gas stream is harvested from the membranes and a byproduct stream is removed from the membranes. Gaskets, such as flexible graphite gaskets, are used to achieve seals around the feed and permeate flow channels.

The thin, planar, hydrogen-permeable membranes are preferably composed of palladium alloys, most especially palladium with 35 wt % to 45 wt % copper. These membranes are typically formed from a thin foil that is approximately 0.001 inches thick. It is within the scope of the present invention, however, that the membranes may be formed from hydrogen-selective metals and metal alloys other than those discussed above and that the membranes may have thicknesses that are larger or smaller than discussed above. For example, the membrane may be made thinner, with commensurate increase in hydrogen flux. The hydrogen-permeable membranes may be arranged in any suitable configuration, such as arranged in pairs around a common permeate channel as is disclosed in the incorporated patent applications. The hydrogen permeable membrane or membranes may take other configurations as well, such as tubular configurations.

Another example of a suitable pressure-separation process is pressure swing absorption (PSA). Therefore, region 106 may alternatively include suitable structure for performing pressure swing absorption.

Reformer 100 may further include a polishing region 116, such as shown in FIG. 12. Polishing region 116 receives the hydrogen-rich stream 110 from separation region 106 and further purifies the stream by reducing the concentration of, or removing, compositions that may damage fuel cell stack 34, such as carbon monoxide and carbon dioxide. Region 116 includes any suitable structure for removing or reducing the concentration of the selected compositions in stream 110. For example, when the product stream is intended for use in a PEM fuel cell stack or other device that will be damaged if the stream contains more than determined concentrations of carbon monoxide or carbon dioxide, it may be desirable to include at least one methanation catalyst bed 118. Bed 118 converts carbon monoxide and carbon dioxide into methane and water, both of which will not damage a PEM fuel cell stack. Polishing region 116 may also include another hydrogen-producing device 120, such as another reforming catalyst bed, to convert any unreacted feedstock into hydrogen gas. In such an embodiment, it is preferable that the second reforming catalyst bed is upstream from the methanation catalyst bed so as not to reintroduce carbon dioxide or carbon monoxide downstream of the methanation catalyst bed.

In the preceding discussions, attention was focused on particular examples of suitable sulfur-absorbent materials 46 for use with sulfur-absorbent beds 44 according to the present invention. It is within the scope of the invention that LTS catalyst beds may be used alone or in combination with other sulfur-removal beds, such as schematically illustrated in FIG. 15 at 160. Examples of beds 160 include beds containing traditional sulfur-absorbent materials 162, such as zinc oxide, nickel oxide, iron oxide, and/or activated charcoal. Another example of a suitable bed 160 is a desulfurization catalyst bed 164. Desulfurization catalysts are used to convert sulfur compounds that are not generally absorbed into traditional sulfur-absorbent materials 162 into hydrogen sulfide through a process called hydrosulfurization. In this process, a carbon-containing feedstock is contacted with the catalyst at high temperature and in an operating environment containing a high partial pressure of hydrogen to convert the sulfur-containing compounds, such as mercaptan sulfur, organic sulfurs like thiophenes, and chemically combined sulfides and disulfides, which are not readily removed by traditional sulfur-absorbent materials, into hydrogen sulfide. The hydrogen sulfide can then be removed by a conventional sulfur-absorbent material.

In FIG. 15, bed 160 is shown preceding bed 44, but the reverse order may also be used, as indicated in FIG. 16. Similarly, bed(s) 44 may be preceded and succeeded by beds 160, as schematically illustrated in FIG. 17, and beds 160 may have the same or different constructions. As a further example, FIG. 18 schematically illustrates that bed 44 may include material 46 as well as other sulfur-removal materials, such as materials 162.

### Industrial Applicability

The present invention is applicable to all fuel processing and fuel cell systems in which the feed stream contains a carbon-containing feedstock that may include or be contaminated with sulfur-containing compounds.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower or equal in scope to the original claims, are also regarded as included within the subject matter of the inventions of the present disclosure.

I Claim:

1. A fuel processing system, comprising:
a sulfur-removal assembly including at least one sulfur-absorbent bed adapted to receive a stream containing a carbon-containing feedstock and sulfur compounds, wherein the bed contains a sulfur-absorbent material that is adapted to reduce the concentration of the sulfur compounds in the stream, and further wherein the sulfur-absorbent material is adapted to catalyze the conversion of carbon monoxide and water to yield hydrogen gas and carbon dioxide at temperatures less than approximately 350° C.; and
a fuel processor adapted to receive a feed stream that includes the carbon-containing feedstock from the sulfur-removal assembly and to produce a product hydrogen stream containing hydrogen gas therefrom.

2. The fuel processing system of claim 1, wherein the sulfur-absorbent material is selected from a group of materials that does not catalyze the formation of methane from the carbon-containing feedstock when the bed is operated at a temperature of less than approximately 400° C.

3. The fuel processing system of claim 1, wherein the sulfur-absorbent material is selected from a group of materials that does not catalyze the formation of coke from the carbon-containing feedstock when the bed is operated at a temperature of less than approximately 400° C.

4. The fuel processing system of claim 1, wherein the sulfur-absorbent material is more reactive than zinc oxide at removing sulfur compounds from the carbon-containing feedstock at temperatures in the range of approximately 100° C. and approximately 400° C.

5. The fuel processing system of claim 1, wherein the sulfur-absorbent material is adapted to absorb organic sulfur compounds.

6. The fuel processing system of claim 1, wherein the sulfur-absorbent material is selected from a group of materials that are poisoned when exposed to sulfur compounds.

7. The fuel processing system of claim 6, wherein the sulfur-absorbent material is selected from a group of materials that are poisoned when exposed to sulfur compounds present in concentrations in the range of 1-10 ppm at temperatures less than approximately 350° C.

8. The fuel processing system of claim 1, wherein the sulfur-absorbent material includes 10-90% copper oxide.

9. The fuel processing system of claim 8, wherein the sulfur-absorbent material includes 20-60% copper oxide.

10. The fuel processing system of claim 9, wherein the sulfur-absorbent material further includes zinc oxide.

11. The fuel processing system of claim 1, wherein the sulfur-absorbent material includes chromium.

12. The fuel processing system of claim 1, wherein the bed is operated at a temperature in the range of 20° C. and approximately 400° C.

13. The fuel processing system of claim 12, wherein the fuel processing system includes a heating assembly adapted to heat the at least one sulfur-absorbent bed to a temperature in the range of approximately 100° C. and approximately 400° C.

14. The fuel processing system of claim 1, wherein the sulfur-removal assembly includes a plurality of sulfur-absorbent beds containing the sulfur-absorbent material.

15. The fuel processing system of claim 14, wherein the sulfur-removal assembly includes a valve assembly that is adapted to selectively deliver the stream containing the carbon-containing feedstock to at least one but less than all of the sulfur-absorbent beds such that at least one of the sulfur-absorbent beds does not receive a portion of the stream containing the carbon-containing feedstock.

16. The fuel processing system of claim 1, wherein each of the sulfur-absorbent beds containing the sulfur-absorbent material has a capacity of absorbed sulfur and further wherein the fuel processing system includes at least one sensor adapted to measure the percentage of the capacity at which each of the beds is operating.

17. The fuel processing system of claim 1, wherein each of the sulfur-absorbent beds containing the sulfur-absorbent material has a capacity of absorbed sulfur, and further wherein the fuel processing system further includes a controller that is adapted to determine when a threshold value corresponding to a predetermined percentage of the capacity has been reached and to trigger a user-notifying event responsive thereto.

18. The fuel processing system of claim 17, wherein upon determination that a bed is operating above the threshold value, the controller is adapted to send a control signal to a user-notifying device.

19. The fuel processing system of claim 17, wherein the controller includes at least one sensor adapted to measure the percentage of each bed's capacity at which the beds are operating.

20. The fuel processing system of claim 19, wherein each of the sulfur-absorbent beds containing the sulfur-absorbent material includes a sensor in communication with the controller and adapted to measure the percentage of the bed's capacity of absorbed sulfur at which the bed is operating.

21. The fuel processing system of claim 17, wherein the controller includes a memory portion in which at least one threshold value is stored for each of the sulfur-absorbent beds containing the sulfur-absorbent material.

22. The fuel processing system of claim 21, wherein the controller includes a memory portion in which at least a lower and a higher threshold value are stored for each of the sulfur-absorbent beds containing the sulfur-absorbent material, and wherein upon determination that one of the beds containing the sulfur-absorbent material is operating at a capacity that exceeds the lower threshold value, the controller is adapted to send a first control signal to a user-notifying device, and further wherein upon determination that one of the beds containing the sulfur-absorbent material is operating at a capacity that exceeds the higher threshold value, the controller is adapted to send a second control signal to the user-notifying device.

23. The fuel processing system of claim 22, wherein the user-notifying device is adapted to produce different responses responsive to receiving the first and the second control signals.

24. The fuel processing system of claim 1, wherein the sulfur-removal assembly further includes at least one sulfur-removal region adapted to remove sulfur compounds from the carbon-containing feedstock other than with the sulfur-absorbent material.

25. The fuel processing system of claim 24, wherein the at least one sulfur-removal region is adapted to remove sulfur compounds by hydrodesulfization.

26. The fuel processing system of claim 1, wherein the carbon-containing feedstock includes at least one hydrocarbon.

27. The fuel processing system of claim 1, wherein the carbon-containing feedstock includes at least one alcohol.

28. The fuel processing system of claim 1, wherein the feed stream includes water and the fuel processor includes a reforming region with at least one reforming catalyst bed adapted to produce a stream containing hydrogen gas from the feed stream via a reforming reaction and further wherein the product hydrogen stream is formed from the stream containing hydrogen gas.

29. The fuel processing system of claim 28, wherein the stream containing hydrogen gas further includes other gases, and further wherein the fuel processor includes a separation region in which the stream containing hydrogen gas is separated into a hydrogen-rich stream containing at least substantially hydrogen gas and a byproduct stream containing at least a substantial portion of the other gases.

30. The fuel processing system of claim 29, wherein the separation region is adapted to separate the stream containing hydrogen gas into the hydrogen-rich stream and the byproduct stream via a pressure-driven separation process.

31. The fuel processing system of claim 30, wherein the separation region includes at least one hydrogen-permeable membrane positioned to be contacted by the stream containing hydrogen gas, and further wherein the hydrogen-rich stream is formed from a portion of the stream containing hydrogen gas that permeates through the membrane and the byproduct stream is formed from a portion of the stream containing hydrogen gas that does not pass through the membrane.

32. The fuel processing system of claim 31, further comprising a fuel cell stack adapted to receive at least a portion of the product hydrogen stream and to produce an electric current therefrom.

33. The fuel processing system of claim 31, wherein the at least one membrane comprises at least one of palladium and a palladium alloy.

34. The fuel processing system of claim 33, wherein the separation region includes a plurality of hydrogen-permeable membranes arranged in pairs such that each pair of membranes defines a permeate channel therebetween from which the hydrogen-rich stream is produced.

35. The fuel processing system of claim 1, further comprising a fuel cell stack adapted to receive at least a portion of the product hydrogen stream and to produce an electric current therefrom.

36. A fuel processing system, comprising:
a sulfur-removal assembly including at least one sulfur-absorbent bed adapted to receive a stream containing a carbon-containing feedstock and sulfur compounds, wherein the bed contains a sulfur-absorbent material that is adapted to reduce the concentration of the sulfur compounds in the stream, and further wherein the sulfur-absorbent material is selected from a group of materials that does not catalyze the formation of methane or coke from the carbon-containing feedstock when the bed is operated at a temperature of less than approximately 400° C., and further wherein the sulfur-absorbent material is adapted to absorb organic sulfur compounds; and
a fuel processor adapted to receive a feed stream that includes the carbon-containing feedstock from the sulfur-removal assembly and to produce a product hydrogen stream containing hydrogen gas therefrom, wherein the fuel processor includes a reforming region containing at least one reforming catalyst bed in which a mixed gas stream containing hydrogen gas and other gases is produced from a feed stream that includes the stream containing the carbon-containing feedstock and water, and further wherein the fuel processor includes a separation region in which the mixed gas stream is separated via a pressure-driven separation process into a hydrogen-rich stream containing at least substantially hydrogen gas and a byproduct stream containing at least a substantial portion of the other gases.

37. The fuel processing system of claim 36, wherein the sulfur-absorbent material is more reactive than zinc oxide at removing sulfur compounds from the carbon-containing feedstock at temperatures in the range of approximately 100° C. and approximately 400° C.

38. The fuel processing system of claim 36, wherein the sulfur-absorbent material is selected from a group of materials that are poisoned when exposed to sulfur compounds.

39. The fuel processing system of claim 38, wherein the sulfur-absorbent material is selected from a group of materials that are poisoned when exposed to sulfur compounds present in concentrations in the range of 1-10 ppm at temperatures less than approximately 350° C.

40. The fuel processing system of claim 36, wherein the sulfur-absorbent material includes 10-90% copper oxide.

41. The fuel processing system of claim 40, wherein the sulfur-absorbent material includes 20-60% copper oxide.

42. The fuel processing system of claim 41, wherein the sulfur-absorbent material further includes zinc oxide.

43. The fuel processing system of claim 36, wherein the sulfur-absorbent material includes chromium.

44. The fuel processing system of claim 36, wherein the bed is operated at a temperature in the range of 20° C. and approximately 400° C.

45. The fuel processing system of claim 44, wherein the fuel processing system includes a heating assembly adapted to heat the at least one sulfur-absorbent bed to a temperature in the range of approximately 100° C. and approximately 400° C.

46. The fuel processing system of claim 36, wherein the sulfur-removal assembly includes a plurality of sulfur-absorbent beds containing the sulfur-absorbent material.

47. The fuel processing system of claim 46, wherein the sulfur-removal assembly includes a valve assembly that is adapted to selectively deliver the stream containing the carbon-containing feedstock to at least one but less than all of the sulfur-absorbent beds such that at least one of the sulfur-absorbent beds does not receive a portion of the stream containing the carbon-containing feedstock.

48. The fuel processing system of claim 36, wherein each of the sulfur-absorbent beds containing the sulfur-absorbent material has a capacity of absorbed sulfur and further wherein the fuel processing system includes at least one sensor adapted to measure the percentage of the capacity at which each of the beds is operating.

49. The fuel processing system of claim 36, wherein each of the sulfur-absorbent beds containing the sulfur-absorbent material has a capacity of absorbed sulfur, and further wherein the fuel processing system further includes a controller that is adapted to determine when a threshold value corresponding to a predetermined percentage of the capacity has been reached and to trigger a user-notifying event responsive thereto.

50. The fuel processing system of claim 49, wherein upon determination that a bed is operating above the threshold value, the controller is adapted to send a control signal to a user-notifying device.

51. The fuel processing system of claim 49, wherein the controller includes at least one sensor adapted to measure the percentage of each bed's capacity at which the beds are operating.

52. The fuel processing system of claim 51, wherein each of the sulfur-absorbent beds containing the sulfur-absorbent material includes a sensor in communication with the controller and adapted to measure the percentage of the bed's capacity of absorbed sulfur at which the bed is operating.

53. The fuel processing system of claim 49, wherein the controller includes a memory portion in which at least one threshold value is stored for each of the sulfur-absorbent beds containing the sulfur-absorbent material.

54. The fuel processing system of claim 53, wherein the controller includes a memory portion in which at least a lower and a higher threshold value are stored for each of the sulfur-absorbent beds containing the sulfur-absorbent material, and wherein upon determination that one of the beds containing the sulfur-absorbent material is operating at a capacity that exceeds the lower threshold value, the controller is adapted to send a first control signal to a user-notifying device, and further wherein upon determination that one of the beds containing the sulfur-absorbent material is operating at a capacity that exceeds the higher threshold value, the controller is adapted to send a second control signal to the user-notifying device.

55. The fuel processing system of claim 54, wherein the user-notifying device is adapted to produce different responses responsive to receiving the first and the second control signals.

56. The fuel processing system of claim 36, wherein the separation region includes at least one hydrogen-permeable membrane positioned to be contacted by the stream containing hydrogen gas, and further wherein the hydrogen-rich stream is formed from a portion of the stream containing hydrogen gas that permeates through the membrane and the byproduct stream is formed from a portion of the stream containing hydrogen gas that does not pass through the membrane.

57. The fuel processing system of claim 56, wherein the at least one membrane comprises at least one of palladium and a palladium alloy.

58. The fuel processing system of claim 57, wherein the separation region includes a plurality of hydrogen-permeable membranes arranged in pairs such that each pair of membranes defines a permeate channel therebetween from which the hydrogen-rich stream is produced.

59. The fuel processing system of claim 36, further comprising a fuel cell stack adapted to receive at least a portion of the product hydrogen stream and to produce an electric current therefrom.

60. In a steam reformer that is adapted to receive a feed stream comprising water and a carbon-containing feedstock and which includes a reforming region having at least one reforming catalyst bed in which a stream containing hydrogen gas is produced from the feed stream, the improvement comprising: a sulfur-removal assembly comprising at least one sulfur-absorbent bed containing a low temperature shift catalyst upstream from the reforming region and adapted to absorb sulfur-containing compounds from at least a portion of the feed stream prior to delivery to the reforming region.
